(19) United States
(12) Patent Application Publication
(10) Pub. No.: US 2010/0049527 A1
(43) Pub. Date: Feb. 25, 2010

(54) Method and Device for Voice Control of a Device or of a System in a Motor Vehicle

(76) Inventors: Andreas Korthauer, Stuttgart (DE); Lars Placke, Hannover (DE)

Correspondence Address: KENYON & KENYON LLP, ONE BROADWAY, NEW YORK, NY, 10004, US

(21) Appl. No.: 11/883,091

(22) PCT Filed: Feb. 8, 2006
(86) PCT No.: PCT/EP06/50752

§ 371 Date: Dec. 15, 2008

(30) Foreign Application Priority Data
Feb. 17, 2005 (DE) 10 2005 007 317.4

(51) Int. Cl. G10L 23/00

(52) U.S. Cl. 704/275; 704/E11.001

(57) ABSTRACT

A method for voice controlling of a device or of a system in a motor vehicle, the device or the system being capable of being operated both by voice inputs and also by non-voice inputs, in particular through the actuation of switches and/or buttons and/or a touch screen, and in which the user of the device or system, in particular the driver of the motor vehicle, is alerted optically and/or acoustically and/or haptically that voice operation of the device or system is possible, dependent on the presence or absence of particular predefined conditions. In addition, the present invention relates to a device or system for supporting the voice controlling of a device or system in a motor vehicle, with which this method is able to be executed.

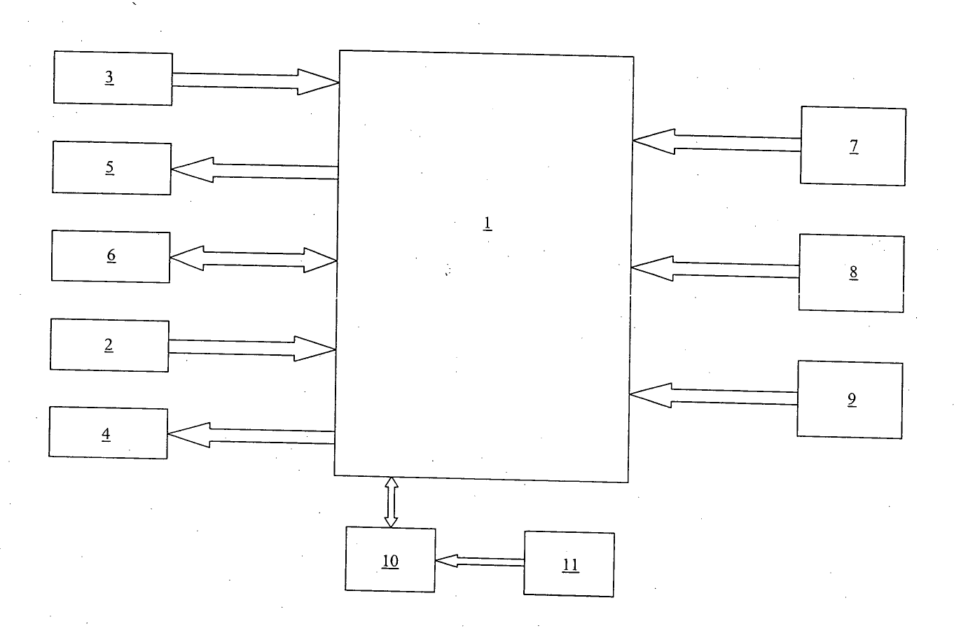

### FIELD OF THE INVENTION

The present invention relates to a method for voice controlling of a device or of a system in a motor vehicle, in which the device or the system can be operated both by voice inputs and by non-voice inputs, in particular by the actuation of switches and/or buttons and/or a touch screen. Such devices or systems can be for example radio devices, car telephone systems, or driver assistance systems, such as a navigation system.

### BACKGROUND INFORMATION

Devices and methods for voice controlling of devices or systems are known for example from German Patent Publication No. DE 100 08 226. They are used in motor vehicles, in particular in the area of infotainment (car radio, playback devices, hi-fi systems) and/or communication devices (mobile telephone, location devices, navigation). At least one microphone is used to pick up voice inputs from the user, which are converted into electrical signals and interpreted as commands to be executed.

In general, in motor vehicles interactive strategies are increasingly being used, in which various sense modalities and various codings, e.g. tones, speech, graphics, and/or text, are used; these are referred to as multimodal interaction strategies. Besides visual representations of information and the possibility of haptic inputs via buttons or touch screens, the possibility of voice operation is increasingly coming into use, both for user inputs and for outputs to the user.

In motor vehicles in particular, voice operation not only represents a very simple and convenient manner of operation, but above all also a very safe one, because it does not interfere with other operating functions or control tasks that have to be carried out manually, e.g. using the steering wheel to keep the vehicle in its lane. Thus, as a rule lane maintenance is better during an operation carried out by voice than during manual operation of a device or system, and this is a significant advantage of voice operation. The significantly lower distraction of the driver from the driving task at hand increases traffic safety not only for the occupants of the vehicle, but also for other traffic participants.

However, in such systems having the additional option of voice operation it is always also possible to use the voice-operable functions in a conventional manner, without voice operation. Thus, voice operations are always user-driven, meaning that the user himself decides whether and when to use voice operation. Here, previous habits of the user or driver can play a large role. This means that it is not always ensured that the driver will take advantage of the safety of voice operation.

The underlying problem of the present invention is, in general, to better exploit the advantages of voice operation, and to create a method of the type named above that invites the driver to execute an interaction by voice, and/or motivates him to continue voice operation.

### SUMMARY OF THE INVENTION

Relative to the known voice operating methods, the method according to the present invention has the advantage that the user or driver of a motor vehicle will be motivated to use voice operation in particular situations, which can result in an increase in traffic safety. The application of the method according to the present invention has the result that the driver is automatically made aware of the possibility of the alternative of voice operation, in order to influence him in such a way as to take advantage of the greater safety offered by voice operation.

The idea on which the present invention is based is that the user of the voice-operable device or system, in particular the driver of the motor vehicle, is alerted optically and/or acoustically and/or haptically to the fact that voice operation of the device or system is possible, dependent on the presence or absence of particular predefined conditions.

In this way, a method is created that is simple to execute and that can contribute to an increase in traffic safety with relatively low outlay and costs. In addition, in this way the driver can be made better aware of the possibility of using the voice to operate functions that he does not execute by voice, either as a result of habit or from lack of knowledge.

Thus, it is particularly advantageous if the user is informed of the possibility of voice operation if he is executing, or has executed, a non-voice-controlled operation of the device or system. The condition for the output of such an information signal that is to be checked according to the present invention is to be found in the behavior of the user, or driver. In this way, the method according to the present invention can also provide particularly effective support for the driver while he is learning the various possibilities of voice operation.

An alternative, or supplemental, variant of the method according to the present invention provides that the user is given a signal of the possibility of voice operation every time he switches on a voice-operable device or system, and/or when he starts the motor vehicle.

According to a first, particularly preferred, specific embodiment of the present invention, it is provided that one or more predetermined parameters of the current state and/or behavior of the user are acquired and/or compared to one or more predefined parameter values, the user being given a signal of the possibility of voice operation if at least one acquired parameter value reaches or exceeds or falls below the associated predefined comparison parameter value.

Such acquirable parameters concerning the state or behavior of the user or driver can preferably be movements of the eyes and/or of the head. These movements can be acquired via separate systems, e.g. via eye-tracking systems for other functions, and can be also used for the execution of the method according to the present invention. For example, frequent back-and-forth movements of the head or of the eyes can indicate a situation in which the driver is looking for buttons or switches of a device or system, so that it makes sense to support the driver by indicating the possibility of voice operation.

According to another, particularly preferred, specific embodiment of the present invention, it is provided that one or more predetermined parameters of the current state of the motor vehicle are acquired, and are compared to one or more predefined parameter values, the user being informed of the possibility of voice operation if at least one acquired parameter value reaches or exceeds or falls below the associated predefined comparison parameter value. The indication to the user is thus outputted dependent on a current driving state. Driving state parameters of modules provided for other functions of the motor vehicle can also be supplied here.

Preferably, the current speed and/or an average speed of the motor vehicle and/or the acceleration or deceleration of the motor vehicle and/or the current steering angle and/or the number of steering angle changes in a particular time period can be acquired as parameters. For example, a significantly increasing number of frequent smaller changes in the steering angle can also indicate a situation in which it could make sense to support the driver by indicating the possibility of voice operation of a device or system.

According to a third preferred specific embodiment of the present invention, it is provided that one or more predetermined parameters of the current surrounding environment of the motor vehicle are acquired and are compared to one or more predefined parameter values, the user being alerted to the possibility of voice operation if at least one acquired parameter value reaches or exceeds or falls below the associated predefined comparison parameter value. Here, the indication to the user is issued dependent on a current traffic situation.

Here, preferably the type and/or course and/or composition of the roadway currently being traveled, and/or travel past particular traffic signs and/or the current traffic density can be acquired as parameters. For example, on highways, or given acquisition of a speed limit, or given particularly high traffic density, a situation could be present in which it would make sense to provide an indication of the possibility of voice operation of a device or system in order to support the driver.

Of course, the three conditions named above, concerning the state of the driver, the vehicle, or the surrounding environment of the vehicle, can be acquired not only individually, but also simultaneously, and can be checked in order to determine whether an indication according to the present invention should be issued to the driver.

Another alternative is to alert the user to the possibility of voice operation of a device or system dependent on the time, in particular at regular time intervals.

In addition, it is particularly advantageous if the user or driver is acoustically alerted to the possibility of voice operation in a communication interface (HMI) through the outputting of pre-stored speech segments, which may also be present in different languages. For example, the following indication can be outputted: “Please make the input by voice.” This also gives the driver a direct, logical point of entry into the voice dialog. In principle, however, the indication according to the present invention can also be outputted differently, for example through changes on the graphic input mask. The driver can also be given the indication by optical display means, which can be formed in particular by a display device integrated into an instrument cluster of the motor vehicle. In particular, the transition to voice operation can be made easier for the driver by providing that, during conventional operation of the device or system, in addition to the visual outputs the corresponding voice outputs for voice operation are also outputted at the same time.

In addition, the present invention relates to a device or system that is suitable for the execution of the method according to the present invention. It is particularly advantageous if the device has storage means in which software that executes the method according to the present invention can be stored. The storage means can preferably also store the comparison parameter values that are required during the execution of the method in order to determine the conditions under which an indication of voice operability is to be issued.

A device corresponding to the method described above for supporting the voice controlling of a device or of a system in a motor vehicle preferably includes at least one device or system, situated in or on a motor vehicle, that is capable of being operated both by voice inputs and also by non-voice inputs, in particular by the actuation of switches and/or buttons and/or a touch screen, means for acquiring at least one state of the driver and/or of the motor vehicle and/or of the surrounding environment of the motor vehicle, a storage device for storing predefined comparison values, a comparator unit for comparing the acquired state values with the comparison values, and signal means that are connected to the comparator unit and that preferably operate optically and/or acoustically, by which the user of the device or system, in particular the driver of the motor vehicle, can be alerted, dependent on the results supplied by the comparator unit, to the fact that the device or system is capable of being operated by voice.

Using such a device, the driver can be alerted to the possibility of voice operation given the presence or absence of particular predefined conditions or situations, or when the acquired state values reach or exceed or fall below the comparison values. Advantageously, in a device or system according to the present invention a corresponding indication can also take place if the driver is carrying out a conventional mode of operation even though voice operation of the device or system being operated would also be possible. As in the previously described method, the device according to the present invention is also intended to motivate the driver to take advantage of voice operation in order to increase driving safety. The device according to the present invention can be realized economically, with a relatively low outlay.

### BRIEF DESCRIPTION OF THE DRAWING

The FIGURE shows a device according to the present invention for supporting the voice controlling of a system in a motor vehicle that is capable of being operated both by voice inputs and also by non-voice inputs.

### DETAILED DESCRIPTION

The FIGURE shows a driver assistance system 1, which can for example be a navigation system for supporting the driver in finding the best possible driving route. System 1 can be operated by the driver on the one hand in a conventional manner via knobs, buttons, and/or switches 2, as well as, additionally, also via a voice recognition module 3. In order to output information, driver assistance system 1 is connected to a display device 4 in an instrument cluster of the motor vehicle, and is connected to a voice output module 5. In addition, a touch screen 6 is present as an additional user interface (HMI, or Human-Machine Interface), via which information can be issued to the driver by system 1, and via which the driver can also make inputs.

In addition, System 1 for executing the method according to the present invention is connected to means for acquiring at least one state 7 of the driver and at least one state 8 of the motor vehicle and at least one state 9 of the surrounding environment of the motor vehicle. State parameters 7, 8 and 9 acquired in this way are compared, in a comparator unit 10 connected to the assistance system 1, to particular predefined comparison values that are stored in a storage unit 11. When the predefined comparison values are reached, and/or if a predeterminable or settable distance from the predefined comparison values has been fallen below, speech output module 5, which is connected to comparator unit 10 via system 1, provides the driver with an indication that the driver can, or should, more logically operate assistance system 1 using speech inputs.

Here, the present invention takes into account the respective situation of the driver and/or of the motor vehicle in order to provide support to the driver precisely at the time at which the use of voice operation would provide a significant advantage with respect to driving safety. This holds above all in situations in which there is a high degree of stress on the driver, or if an increased degree of attention to the driving task at hand is required, in particular given high traffic density, or if the driver is for example inattentive or tired.

Although the present invention has here been described only on the basis of preferred exemplary embodiments, it is not limited thereto, but rather is capable of being modified in many ways. In particular, the conditions or states 7, 8, 9 that are to be checked are not limited to the cited examples, but rather can include arbitrary states, situations, and/or processes. The user of voice-operable device or system 1 can also be different from the driver of the motor vehicle.

1-13. (canceled)

14. A method for voice controlling of a device or of a system in a motor vehicle, the device or the system being capable of being operated both by voice inputs and by non-voice inputs, by an actuation of at least one of switches, buttons and a touch screen, the method comprising:
providing a driver of the motor vehicle a signal, at least one of optically, acoustically and haptically, that voice operation of the device or the system is possible, dependent on a presence or absence of predefined conditions.

15. The method as recited in claim 14. wherein the user is alerted to the possibility of voice operation if he is carrying out, or has carried out, a non-voice-controlled operation of the device or system.

16. The method as recited in claim 14, wherein the user is alerted to the possibility of voice operation when the device or system is switched on, or when the motor vehicle is started.

17. The method as recited in claim 14, wherein at least one predetermined parameter of the state or of the behavior of the user is acquired and is compared to at least one predefined parameter value, the user being alerted to the possibility of voice operation if at least one acquired parameter value reaches or exceeds or falls below at least one predefined parameter value.

18. The method as recited in claim 17, wherein the eye movements and/or head movements of the user, in particular of the driver, are acquired as parameters.

19. The method as recited in claim 14, wherein at least one predetermined parameter of the state of the motor vehicle is acquired and is compared to at least one predefined parameter value, the user being alerted to the possibility of voice operation if at least one acquired parameter value reaches or exceeds or falls below at least one predefined parameter value.

20. The method as recited in claim 19, wherein the current speed and/or an average speed and/or the acceleration or deceleration of the motor vehicle and/or the current steering angle and/or the number of changes of steering angle in a particular time period are acquired as parameters.

21. The method as recited in claim 14, wherein at least one predetermined parameter of the surrounding environment or of the state of the surrounding environment of the motor vehicle is acquired and is compared to at least one predefined parameter value, the user being alerted to the possibility of voice operation if at least one acquired parameter value reaches or exceeds or falls below at least one predefined parameter value.

22. The method as recited in claim 21, wherein the type and/or course and/or constitution of the roadway currently being traveled on, and/or traffic signs and/or the density of traffic in which the motor vehicle is situated, are acquired as parameters.

23. The method as recited in claim 14, wherein the user is alerted to the possibility of voice operation at regular time intervals.

24. The method as recited in claim 14, wherein the user is alerted to the possibility of voice operation acoustically, through the outputting of speech segments.

25. A device for supporting the voice controlling of a device or of a system in a motor vehicle, the device or the system being capable of being operated both by voice inputs and by non-voice inputs, by an actuation of at least one of switches, buttons and a touch screen, the device comprising:
means for providing a driver of the motor vehicle a signal, at least one of optically, acoustically and haptically, that voice operation of the device or the system is possible, dependent on a presence or absence of predefined conditions.

26. A device for supporting the voice controlling of a device or of a system in a motor vehicle, comprising:
at least one device or system that is situated in or on a motor vehicle and that is capable of being operated both by voice inputs and by non-voice inputs, through an actuation of at least one of switches, buttons and a touch screen;
means for acquiring at least one state of at least one of a driver, the motor vehicle and a surrounding environment of the motor vehicle;
a storage device for storing predefined comparison values;
a comparator unit for comparing acquired state values with the comparison values; and
a signal arrangement, connected to the comparator unit, by which a user of the device or of the system is able to be alerted that the device or the system is capable of being operated by voice, dependent on results supplied by the comparator unit, when the acquired state values reach, exceed or fall below the comparison values.
